(19) United States
(12) Patent Application Publication
(10) Pub. No.: US 2015/0258921 A1
(43) Pub. Date: Sep. 17, 2015

(54) Child Seat Having Sliding Engagement with Base Member

(71) Applicants: Edward Chung, Gaithersburg, MD (US); James Chung, Gaithersburg, MD (US)

(72) Inventors: Edward Chung, Gaithersburg, MD (US); James Chung, Gaithersburg, MD (US)

(21) Appl. No.: 14/211,554

(22) Filed: Mar. 14, 2014

(51) Int. Cl. B60N 2/28

(52) U.S. Cl. CPC B60N 2/2821; B60N 2/286

(57) ABSTRACT

A child safety seat that includes a base member and a seat member, wherein the seat member includes a seat support surface and a back support surface that are positioned to orient an individual in a forward direction, and at least one groove is provided on the bottom surface of the seat member and the groove is oriented in a direction transverse to the forward direction, and the base includes a rail member that is also oriented in direction transverse to the forward direction and the rail is adapted to be received in the groove in a sliding engagement.

### TECHNICAL FIELD

The present invention relates generally to methods and apparatus for securing a children including infants in vehicles or other devices.

### BACKGROUND OF THE INVENTION

The secure restraining of children riding in vehicles is important to their safety and many jurisdictions throughout the world have laws that require the use of seatbelts and special car seats that are specifically designed to protect children. On class of these devices are systems that receive an infant carrier. Infant carriers are typically comprised of an external thermoplastic shell and interior padded surface on which the child sits. These seats typically include a belt retaining system. Some belt retaining systems include attachment points that allow a belt to be secured al a location between the legs and at locations over the child's shoulders. These carriers and often designed to be received in complementary child strollers, carriages, stands, swings, and car seat systems. Some systems use a base member onto which the other shell is received and locked into place with a mechanical latch.

Most cars typically require that the carrier member be lifted past at least one lateral support member that is affixed to the car's existing seat. As such the mechanics of many of these systems require the user to lift the seat when the user's arms are outwardly extended in order to position the seat in the correct location on the base member to secure the seat. This exercise can put strain on the user's arms and back and, as the child grows, requires the user to have adequate strength to perform the exercise. Further, for some vehicles that have seats lower to the ground, the user must put his or her head into the car during the exercise and bend down and over which results in an uncomfortable position. In connection with vehicles such as sport utility vehicles, vans and trucks, the seat may be elevated and user may be able to keep his or head outside the vehicle but the exercise of placing the seat into the base member may require the user's arms to be extended laterally in an uncomfortable and unnatural position.

### SUMMARY OF THE INVENTION

The present invention provides an improved manner in which to secure an infant carrier into a car seat base support member. More particularly, the present invention is directed to an infant carrier and receptive base member that is designed to be secured to the vehicles using existing seatbelt restraining systems. The base member is designed to receive and secure an infant carrier or other removable child seat wherein the seat is received onto the base member by sliding the seat element on to rails form on the base member in a lateral direction. The rails also function to prevent the seat from being displaced in a direction either vertically or in a direction perpendicular to the orientation of the rails. The present invention allows a user to position the seat at a location substantially lateral to the base member and then slide the seat into a position on a based member. When the seat member is in the position, it can be locked into place by mechanical locking or latching elements preventing movement on the rail.

According to embodiments of the invention, the seat is received on to the base member in a lateral direction until it reaches a seated and locked position. A number of embodiments that allow for this lateral sliding engagement are disclosed. Accordingly, the present invention allows a user to rest the edge of the infant carrier on the car seat as the seat is aligned with the complementary base member. The seat is then laterally slid into a home position and locked. Consequently, the user does not have to attempt to lift the weight of the carrier in a vertical direction or perpendicular direction with his or arms extended in order to secure or remove a child strapped into the seat from a car.

The foregoing description and the following detailed description are explanatory of the present invention, but are not intended to be restrictive thereof or limiting of the advantages which can be achieved by this invention. Additionally, it is understood that the foregoing summary and subsequent detailed description are representative of embodiments of the invention, and are neither representative nor inclusive of all subject matter and embodiments within the scope of the invention. Thus, the accompanying drawings, referred to herein and constituting a part hereof, illustrate embodiments of this invention, and, together with the detailed description, serve to explain principles of embodiments of the invention.

### BRIEF DESCRIPTION OF THE DRAWINGS

FIG. 1 is a perspective front view of a first embodiment of the invention.

FIG. 2 is a perspective bottom view of the first embodiment of the invention.

FIG. 3 is a perspective view of a seat based member according to a first embodiment of the invention.

FIG. 4 is a side view in elevation of a seat and based member according to an embodiment of the invention.

FIG. 5 is a perspective view of an alternative embodiment of a based member element of the invention.

FIG. 6 is a perspective view of an alternative embodiment of a based member element of the invention.

FIG. 7 is a perspective view of an alternative embodiment of a base member element of the invention.

FIG. 8 is a perspective view of an alternative embodiment depicting the bottom surface of a seat.

FIG. 9 is a perspective view of an embodiment of a rail that includes a series of wheels that are seated along the top surface.

FIG. 10 is a sectional view of the rail depicted in FIG. 9.

FIG. 11 perspective view of a further embodiment of a rail member that includes a series of bearings that are seated along the top surface of the rail

FIG. 12 is a sectional view of the rail depicted in FIG. 11.

FIG. 13 is a perspective view of a peg member that may be received in a groove in accordance with a further embodiment of the invention.

### DETAILED DESCRIPTION OF THE INVENTION

The various aspects, features, and advantages of embodiments of the invention, including both as to structures and operation, are more readily apparent when the invention is considered in the light of the following description made in conjunction with the accompanying drawings. As discussed above these embodiments are intended to be exemplary and not limiting, and in which like reference numerals designate the same or similar parts, elements, or functions throughout the various figures.

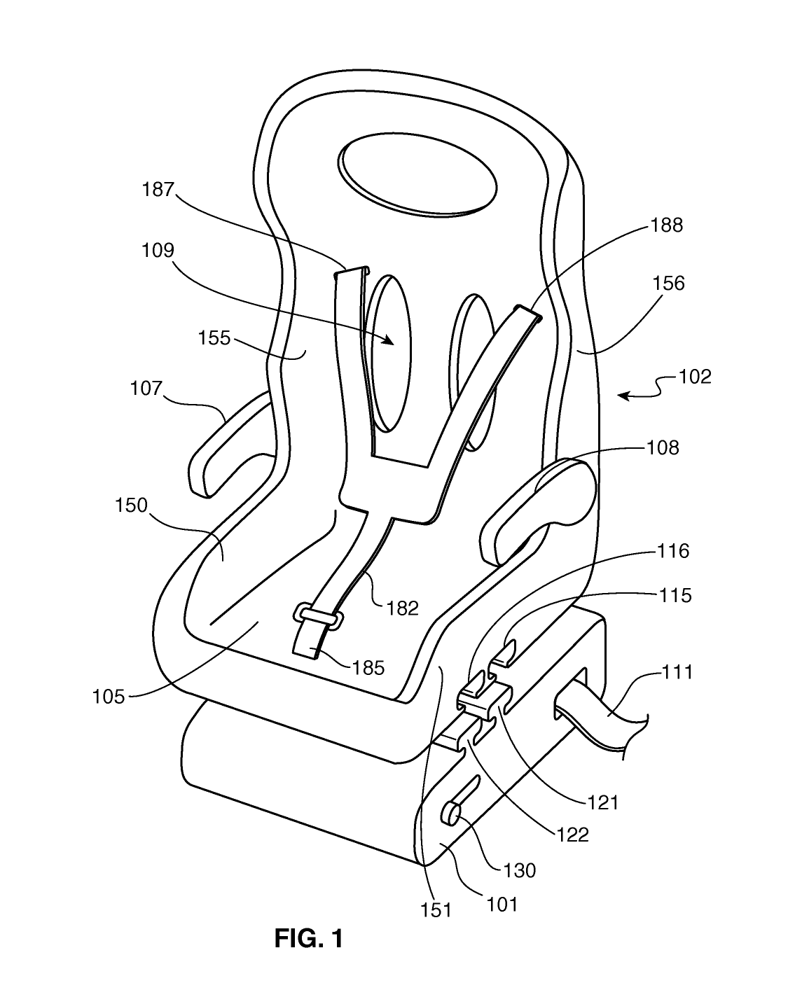

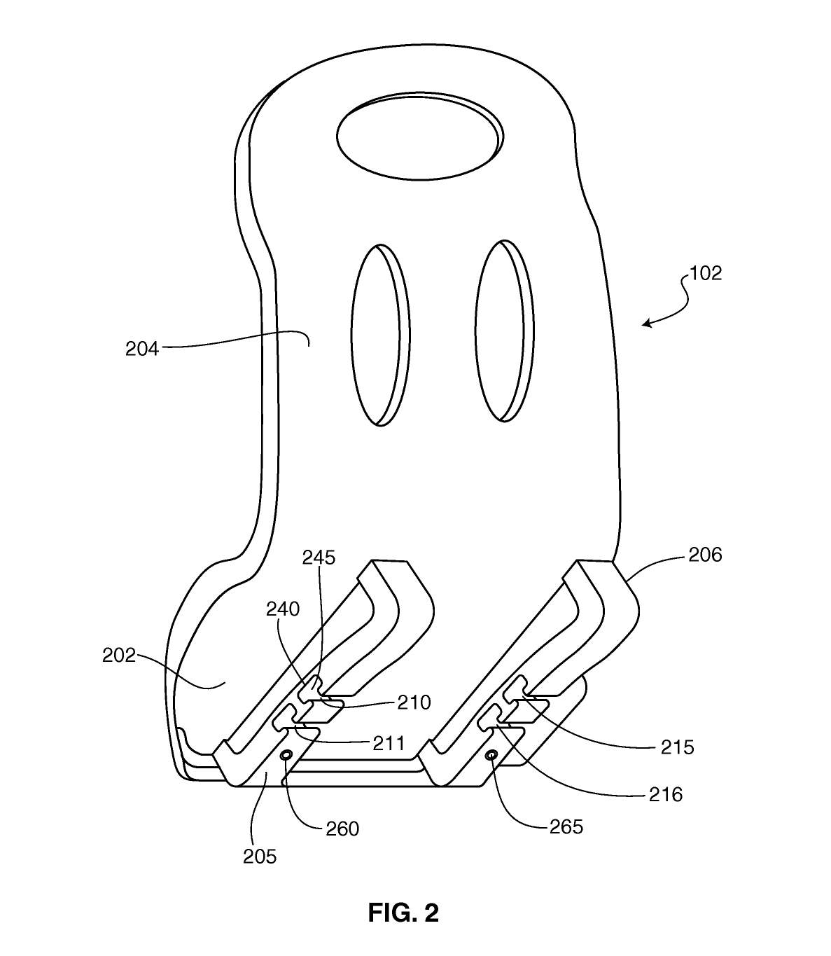

Now referring to FIG. 1, according to a first embodiment of the invention, a child's car seat and complementary base member is disclosed. The seat 102 includes a rear back rest section and seat area 105. On opposite sides of the seat armrests 107 and 108 are provided. Formed in a rail section that is integral with the bottom of the seat are two parallel grooves 116 and 115. Grooves 116 and 115 are re sized and shaped to receive rails 122 and 121 that extend from a top surface of the base member element 101. In a preferred embodiment the outer shell of the seat and base member is comprised of a thermosetting resin. Most thermosetting resins are generally characterized by their hardness, rigidity and resistance to surface scratching. Thermosetting resins that may be used for the outer layer of the present invention include: polyester resin, vinyl ester resin, epoxy resins, phenolic resins and urethane. The seat surface 109 and back rest 109 may include a suitable resilient material such a foam to provide comfort to the intended user. The resilient material is covered by a fabric or a synthetic resin such a vinyl or fabric comprised of polypropylene. The base member is secured to a support surface such as a car seat by belt 111. As best seen in FIG. 2, extending from the bottom surface of the seat region are two parallel rail members 205 and 206 that serve to elevate the seat from a support surface. Two grooves are provided in each rail member 205 and 206 that transverse the rail members in a direction perpendicular to the direction of the rail.

The groove provided on the bottom of the seat surface has a side profile wherein the bottom of the groove has a larger dimension that the lateral opening. For example, groove 210 depicted in rail 205 has a top oval top section 240 and a bottom rectangular section 245. Also depicted are apertures 260 and 265 that receive locking elements. The seat is provided with lateral seat members 150 and 151 to assist with the retention of the passenger within the seat and lateral wing back elements 155 and 156 that also assist with retaining the passenger within the seat. The seat depicted in FIG. 1 also includes a seat belt restraining system 182 that includes attachment points 185, 187 and 188.

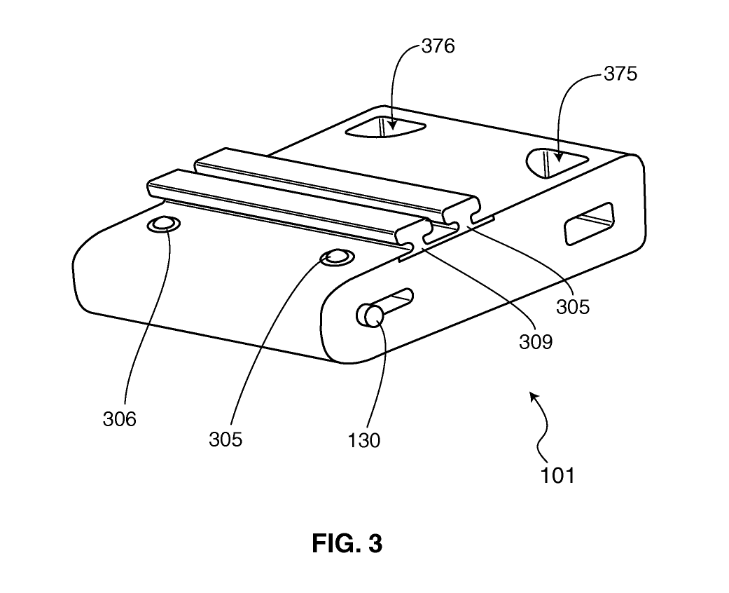

Referring now to FIG. 3, a base member is depicted that includes two rails 305 and 309 that extend from the top surface. In embodiments, the rails are comprised of metal such as steel or aluminum and attached to the base member by suitable fasteners such as screws, nuts and bolts or rivets. Passage 375 and 376 are provided through the base member 101 to receive safety belts and allow the base member 101 to be securely fastened to an automobile seat. Locking members 305 and 306 are biased by springs (not shown) and allow the edge of the rails 205 or 206 to downwardly displace the member until the openings 260 and 265 are in alignment with the members 306 and 305 wherein they are locked into position. The locking members may be released by application of pressure on button 130 which is attached to rod that will rotate a gear that engages the locking member and pushes the drive member downward and against the force of the biasing spring.

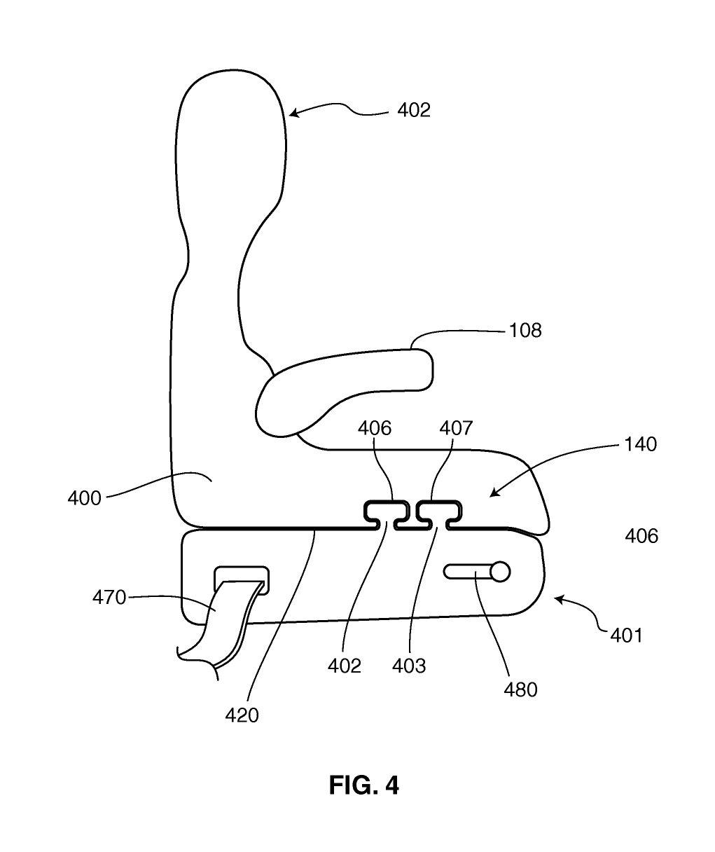

FIG. 4 depicts a side view of an alternative embodiment that depicts rail members 402 and 403 in engagement within opposite grooves 406 and 407 that are formed within the bottom surface 420 of a seat member 400. As can be seen by the side view, the engagement of the rail and grooves prevent movement of the seat member 400 with respect to the base member 401 in any direction that is perpendicular to the orientation of the rails 402 and 403 and grooves 407. As such, if the vehicle in which the seat is attached comes to an abrupt stop, the seat will be held firmly in place on base member 402 which is in turn fastened to the integral car seats by belt 470. In this embodiment, the seat and base member also use a locking member that prevents movement along the rails after the seat and base member are in a desired central position. In this embodiment, the locking member 409 is also spring biased and can be downwardly displaced can be by rotation of the handle 480. In this embodiment the mechanics of locking member function like that of a conventional door latch. Handles are provided on both sides of the base member to allow access to the locking member from either side of the device.

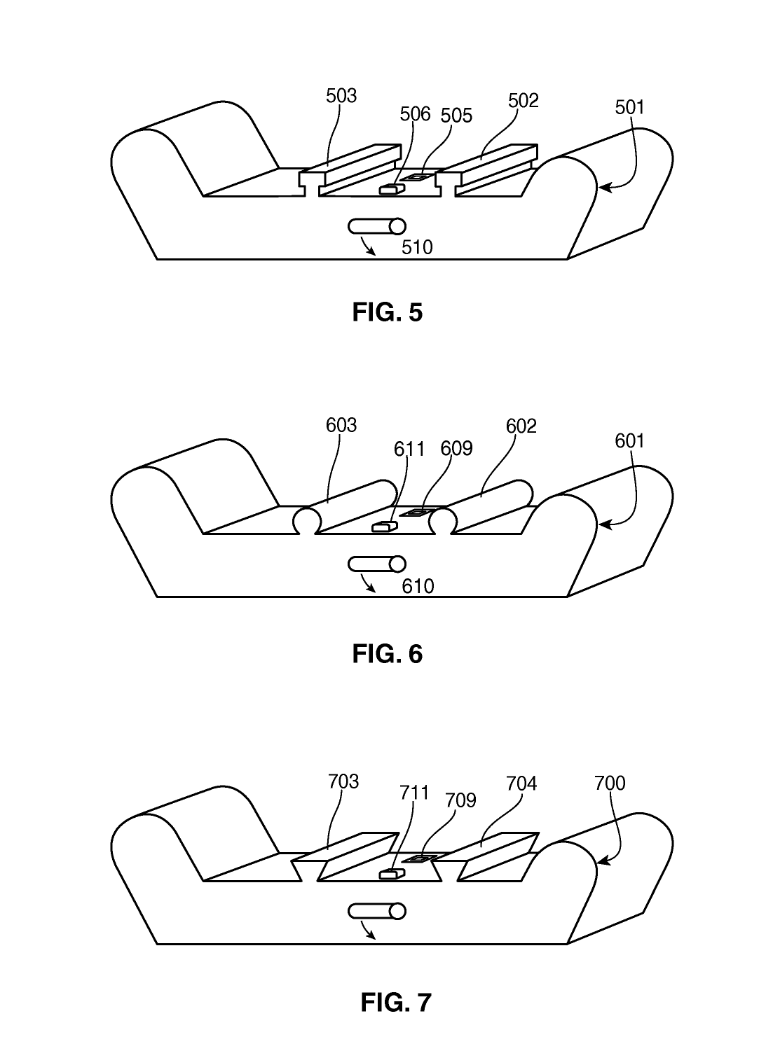

FIG. 5 depicts a further embodiment of a base member or carriage 501. In this embodiment the rails 502 and 503 have a rectilinear profile and are designed to be received by opposite shaped grooves on a seat member. Like the previous embodiments, the device has a locking device that prevents movement of the seat with respect to the rails after the seat is in the home and locked position. The locking member 505 and 506 are spring biased and can be displaced by rotation of handle 510. In yet a further contemplated embodiment a transverse section of the rails has a circular profile. Once again the shape of the rails and their cooperation with complementary grooves will lock the seat to the base member and prevent motion in all directions with the exception of sliding in the same direction as the orientation of the rails. The sliding along the direction is prevented by locking element 611 and 609 that are controlled by handle 610. FIG. 7 depicts yet a further embodiment of a base member 700 having a rail arrangement wherein the rails 701 and 703 have generally an inverted triangular profile. The other elements of the base member are similar to that depicted in FIGS. 5 and 6.

Now referring to FIG. 8, in an alternative embodiment of the invention, the bottom surface 805 of the seat member 810 and underneath the seat region 807 is generally planar. Two continuous grooves 810 and 811 are provided in the bottom surface 805 and are adapted to receive complementary rail elements.

It is apparent that present structures as disclosed allows a car seat or infant carrier to be easily positioned and secured onto a base member by orienting the grooves with the rails and sliding the seat along the rails until it locks into a seated position. The present arrangement therefore avoids the need to lift the seat in a vertical direction which reduces muscle stress on the user. The child or infant can be secured within the seat or carrier using conventional straps.

While the embodiments depicted herein show rails provided on a base member and grooves provided on the bottom of the car seat or infant carrier, it is contemplated that the respective part may be reversed wherein the rails are on the removal infant seat and the grooves are provided on the base member or base member. It is also contemplated that additional features, such as lateral guide member to assist with the alignment of the rails and grooves may be provided.

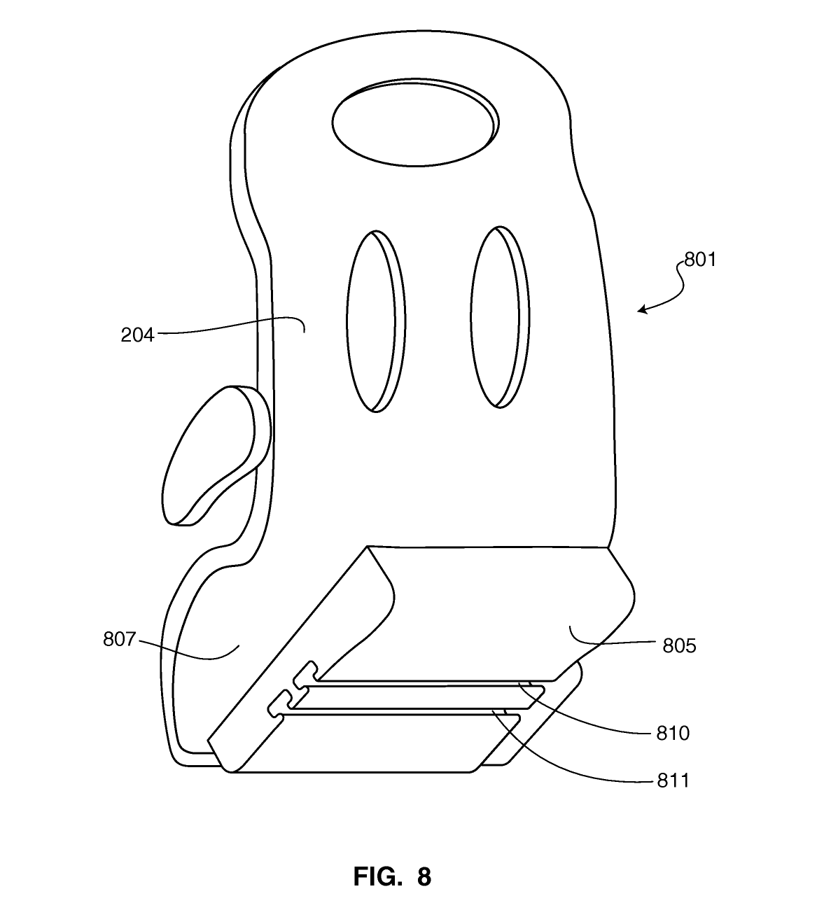

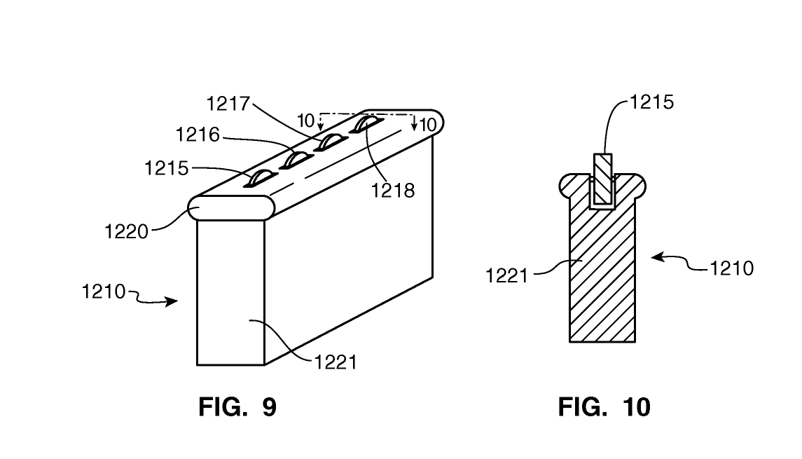

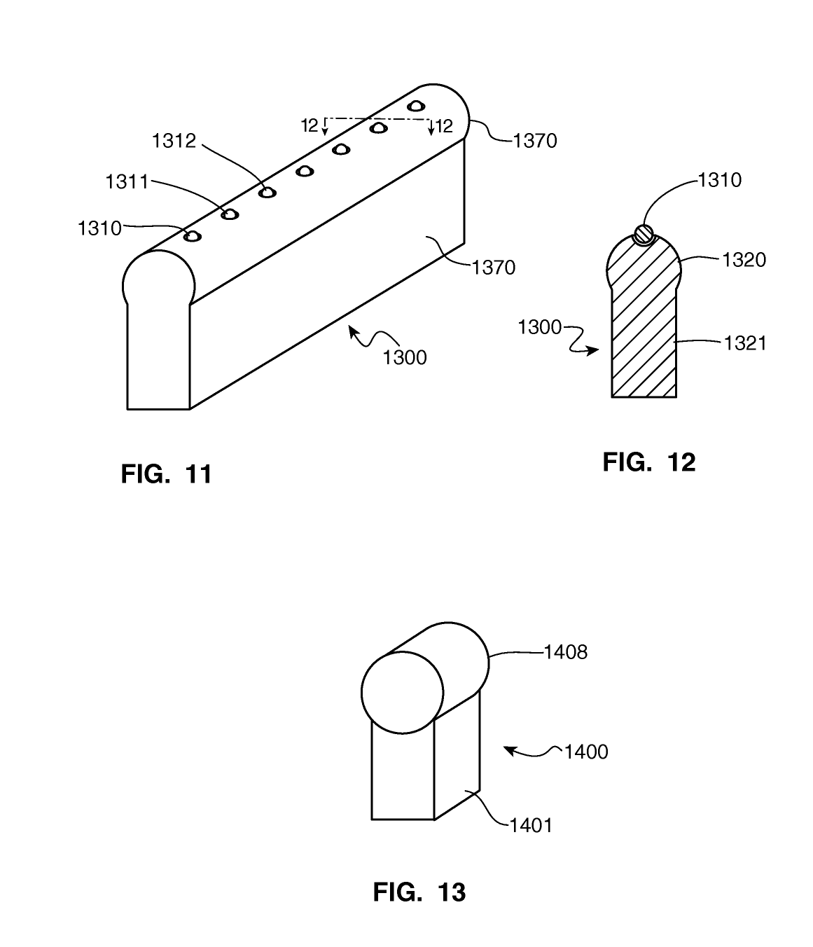

FIGS. 9 and 10 depicts an alternative embodiment of a rail element 1210 that includes a series of wheels 1215, 1216, 1217 12,18 that are mounted to allow them to rotate in the top shoulder section 1220 of the rail that extends from the stem section 1221. The wheels allow a seat member set to easily slide across the base member. FIGS. 11 and 12 depict yet a further alternative of a rail member 1300 that is provided with a series of spherical bearings such as 1310, 1311, 1312. The bearings are located on the top section 1320 of rail 1330 that extends from stem section 1321. The bearings are mounted for rotation and facilitate the sliding of the seat member across the rail.

FIG. 13 illustrates a peg member 1400 that may be received in a groove as an alternative to an extended rail. Like the rails, the peg 1400 has a stem section 1401 and an enlarged head that can be received in a complementary section of a groove. In preferred embodiments, a plurality of pegs may extend from a base member and be oriented in a line so that they may engage a groove located on a seat member.

The present invention has been illustrated and described with respect to specific embodiments thereof, which embodiments are merely illustrative of the principles of the invention and are not intended to be exclusive or otherwise limiting embodiments. Accordingly, although the above description of illustrative embodiments of the present invention, as well as various illustrative modifications and features thereof, provides many specificities, these enabling details should not be construed as limiting the scope of the invention, and it will be readily understood by those persons skilled in the art that the present invention is susceptible to many modifications, adaptations, variations, omissions, additions, and equivalent implementations without departing from this scope and without diminishing its attendant advantages. It is further noted that the terms and expressions have been used as terms of description and not terms of limitation. There is no intention to use the terms or expressions to exclude any equivalents of features shown and described or portions thereof. Additionally, the present invention may be practiced without necessarily providing one or more of the advantages described herein or otherwise understood in view of the disclosure and/or that may be realized in some embodiments thereof. It is therefore intended that the present invention is not limited to the disclosed embodiments but should be defined in accordance with the claims that follow.

We claim:

1. A child safety seat comprising a base member and a seat member, said seat member further comprising a seat support surface and a back support surface said seat support surface and said back support surface positioned to orient an individual in a forward direction, and at least one groove provided on the bottom surface of said seat member, said groove oriented in a direction transverse to said forward direction, and said base member further comprising a rail member that is oriented in direction transverse to said forward direction and said rail is adapted to be received in said groove in a sliding engagement.

2. The safety seat recited in claim 1 further comprising lateral members adjacent to said seat support members and lateral members adjacent to said back support members, a plurality of grooves and a plurality of rails.

3. The safety seat recited in claim 1 wherein said rail and said groove arrangement limit the movement of the seat with respect to the base to a rectilinear direction in the same direction as said rails.

4. The safety seat recited in claim 1 wherein at least one grooves and at least one said rail have a sectional profile wherein the top shoulder of the rail has a larger profile than the stem whereby the engagement of the rail and groove allows for rectilinear movement in the direction defined by said rail but restricts movement in a direction perpendicular to said rail.

5. The safety seat recited in claim 1 further comprising a locking member wherein said locking member restricts the movement of said rail in said groove.

6. The seat recited in claim 1 further comprising bearings within said rails to assist with the movement of the set with respect to the base.

7. The safety seat recited in claim 1 wherein said further comprising wheels provide in said rails to assist the movement of the seat with respect to the base.

8. The safety seat recited in claim 1 wherein said locking member from comprises a spring biased member and a complementary seating region to receive said spring biased member.

9. The safety seat recited in claim 8 wherein said spring biased member is provided in said base member and the seating region is provided in said seat member.

10. The safety seat recited in claim 1 wherein said groove extends substantially across the entire bottom surface of said seat member.

11. The safety seat recited in claim 1 wherein said rail extends substantially across the entire top surface of said base member.

12. A child safety seat comprising a base member and a seat member, said seat member further comprising a seat support surface positioned to orient an individual in a forward direction, and at least one groove provided on the top surface of said base member, said groove oriented in a direction transverse to said forward direction, and said seat member further comprising a rail member that is oriented in direction transverse to said forward direction and said rail is adapted to be received in said groove in a sliding engagement.

13. A child safety seat comprising a base member and a seat member, said seat member further comprising a seat support surface and a back support surface said seat support surface and said back support surface positioned to orient an individual in a forward direction, and at least one groove provided on the bottom surface of said seat member, said groove oriented in a direction transverse to said forward direction, and said base member further comprising at least peg members that are oriented in a line that has a direction transverse to said forward direction and said peg members are adapted to be received in said groove in a sliding engagement.
